(19) United States
(12) Patent Application Publication
(10) Pub. No.: US 2010/0296683 A1
(43) Pub. Date: Nov. 25, 2010

(54) HEADSET WITH ADJUSTABLE HEADBAND

(76) Inventors: Gordon Slippy, Murrysville, PA (US); Doug Keeports, Murrysville, PA (US)

Correspondence Address: WOOD, HERRON & EVANS, LLP, 2700 CAREW TOWER, 441 VINE STREET, CINCINNATI, OH, 45202, US

(21) Appl. No.: 12/470,660

(22) Filed: May 22, 2009

(51) Int. Cl. H04R 25/00

(52) U.S. Cl. 381/377; 381/379

(57) ABSTRACT

A headset includes an element to be held to the head of a wearer and a headband coupled to the element and configured for engaging a head of a wearer to hold the element thereon. The headband includes a plurality of headband arms coupled to pivot with respect to each other. A torsion spring is positioned between the arms and portions of the torsion spring are coupled to the arms for acting on the arms with a torsion force. An adjustment member is coupled between the torsion spring and a headband arm and is operable for adjusting the torsion force of the torsion spring to adjust the torsion force on the arms.

### FIELD OF THE INVENTION

The invention relates to a headset, and particularly to a headset that is worn for long periods of time.

### BACKGROUND OF THE INVENTION

A headset is a common electronic tool used for a variety of different communications tasks. The headset will usually contain one or more earphones or speakers for playing audio to a wearer, and may also include a microphone boom for capturing speech from a wearer. Headsets use a headband to contact a user's head in some fashion, and secure the headset and its components to the user's head.

One type of headband associated with headsets uses a pivoting headband for adjustability. The goal of a headset design, for practical purposes, is to ensure proper fit for a large number of users. A headset with a pivoting headband generally includes two arms that are joined at a pivot point. One or both of the headband arms may be rigid. Often the pivot point is the site of a torsion spring, with one leg of the spring seated in each of the two headband arms. The torsion spring provides a compression force biasing the two arms of the headband into a particular initial position. A user exerts a force to spread or open the headband beyond its initial position and put it on their heads. The compression force provided by the torsion spring helps to keep the headband securely on the user's head.

As conventionally used, the torsion spring within the headband is loaded to a fixed level of torsion, exerting a set biasing torque to the headband arms according to the headband's position. Regardless of the user's head size and the preferred position of the headband, the compression force is set by the spring and the initial position of the headband arms. The load on the torsion spring and the arm positions may not be at a level that is comfortable for all users. Additionally, over time, the load on the torsion spring may decrease as a function of age and wear on the headband, impacting the quality of the fit.

Certain occupational activities, such as customer service, aviation, and voice-directed or voice-assisted work, often require the use of headsets for an extended period of time. Because these headsets may be worn continually for several hours at a time, a comfortable fit is very important. Also, in many work environments, headsets may be shared, and a user may not have the same headset each time he or she works. It is thus desirable to ensure a proper comfortable fit in a headset for various different users.

### SUMMARY OF THE INVENTION

A headset includes a headband with a plurality of arms coupled with a torsion spring, and an adjustment member capable of increasing or decreasing the torsion force of the spring in order to change the torque the spring exerts on the headband arms. In one embodiment, the adjustment member may be a bolt engaging a headband arm and the torsion spring. The adjuster bolt is operable to adjust the torsion spring by disengaging or unlocking it and rotating the bolt. In another embodiment, the adjuster may be a worm gear and worm arrangement, wherein the user adjusts the torsion spring by rotating the worm.

### BRIEF DESCRIPTION OF THE DRAWINGS

The accompanying drawings, which are incorporated in and constitute a part of this specification, illustrate embodiments of the invention and, together with the detailed description of the embodiments given below, serve to explain the principles of the invention.

FIG. 1 is a perspective view of a headset headband according to one embodiment of the present invention.

FIG. 1A is another embodiment of the present invention.

FIG. 1B is another embodiment of the present invention.

FIG. 2 is a partial exploded view of the pivot joint of the headband of FIG. 1.

FIG. 3 is a partial cross-section view of the pivot joint of the headband of FIG. 1 taken along line 3-3.

FIGS. 4A through 4C are cut-away views of the pivot joint of the headband of FIG. 1 showing operation of the adjuster bolt.

FIG. 5 is a perspective view of the pivot joint of a headset headband according to another embodiment of the invention.

FIG. 6 is a perspective cross section view of the pivot joint of FIG. 5 taken along line 6-6 showing operation of the worm-and-gear adjuster.

FIG. 7 is a cut-away view of the pivot joint of FIG. 6.

### DETAILED DESCRIPTION

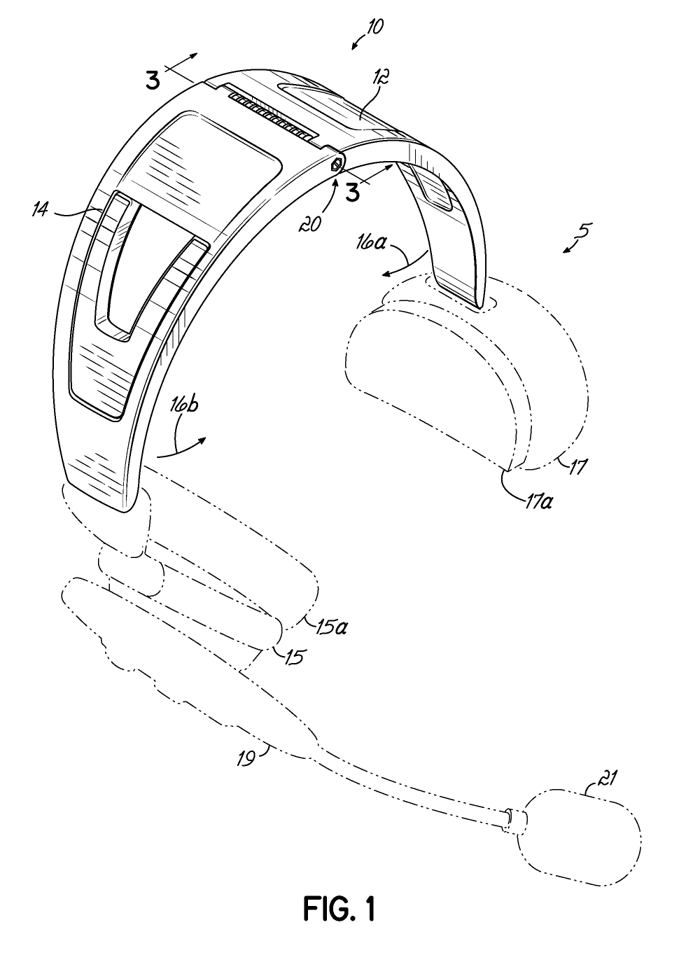

FIG. 1 shows an exemplary headband 10 for a headset 5. The headband 10 of FIG. 1 contains two arms 12 and 14 which are connected at a pivot joint 20. While the embodiment illustrated in FIG. 1 shows a headband with two arms, it would be readily understood by a person of ordinary skill in the art that the present invention might be utilized with a headband having any suitable number of appropriate pivoting sections. For example, FIG. 1B illustrates a headset with a headband 10a having three pivoting sections 12a, 13a, and 14a for providing greater adjustability to the headset for the comfort of a user or wearer.

Each of the arms 12, 14 may be made of a suitable material, such as plastic, metal, or some other lightweight material. The headband 10 is configured to fit comfortably over the top of the user's head. Of course, the invention might also be used on a headset design where the headband 10 extends around some other section of the user's head, such as the rear of the head, rather than directly over the top, as is shown in the illustrated embodiments. The pivot joint 20 exerts torque on the arms 12, 14 which biases them to rotate downward and toward each other in the directions shown by arrows 16a and 16b, biasing the headband 10 closer to a wearer's head to grip their head.

Headset 5 will generally hold or secure one or more elements to the head of a wearer. Accordingly, the arms are coupled at ends thereof to such elements. For example, the embodiment of FIG. 1 includes an earphone or speaker 15 for providing sound to the headset to be heard by a wearer. Opposite the speaker 15 are electronics 17 for operating the headset, such as for voice-directed or voice-assisted applications. Although a single speaker 15 is shown in FIG. 1, the headset might also utilize multiple speakers. For example, FIG. 1A illustrates a headset with two speakers 13, 15. For various applications, such as voice-directed or voice-assisted work, the voice of the wearer may also need to be captured. To that end, the headset might include an appropriate microphone boom 19 that includes a microphone 21 to capture the wearer's speech or other utterances, as shown in FIGS. 1 and 1B. Generally, for comfort, the speakers or elements 13, 15, 17 might include appropriate cushions 13a, 15a, 17a for the comfort of a wearer.

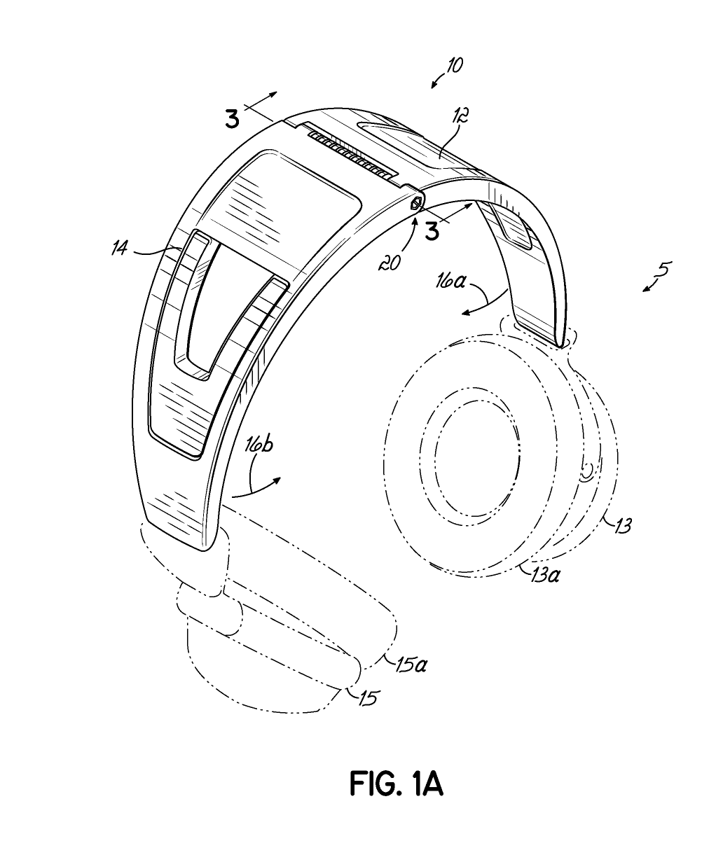

FIG. 2 shows a headband adjustment member or adjuster in accordance with one embodiment of the invention. A torsion spring 30 is the source of the torque exerted by the pivot joint 20 on the arms 12, 14. The torsion spring 30, which is illustrated in the form of a helical spring, has two legs 32 and 34 disposed at either end. One end of the helical spring, such as leg 32, engages arm 12 while the other end, such as leg 34, engages arm 14, as discussed further below. For example, the leg 32 engages and seats in a recess 18 located at the pivoting end of the arm 12, as shown in FIG. 2. In that way, the spring exerts a force on arm 12.

The adjustment member of the present invention includes a locked and unlocked position. The adjustment member is configured for being movable, in the unlocked position, to adjust the torsion force of the torsion spring. Conversely, in the locked position, the adjustment member is prevented from being moved, and thus maintains the desired torsion. In the illustrated embodiment of the invention, the torsion spring may be wound to adjust the head-gripping force provided by the headset.

In the embodiments illustrated, two bushings 22a, 24a extend from the arm 12 and two bushings 22b, 24b extend from the arm 14. The bushing pairs 24a, 24b and 22a, 22b cooperate to provide the pivoting at pivot point 20. The bushing pairs contact or abut against the ends of spring 30. The adjuster element includes an adjuster bolt 42 that extends through openings 40, 41, of the front bushings 22a and 22b. The leg 34 of the torsion spring 30 is coupled to the adjuster bolt 42. A pin 49 or other conventional hinge member may extend through openings 45, 46 in the bushings 24a, 24b in order to properly define the pivot joint 20. As discussed below, the adjuster bolt 42 and its cooperation with shaped opening 40 provides an operable coupling of the spring end leg 34 with arm 14 for translation of the spring force to the leg 14.

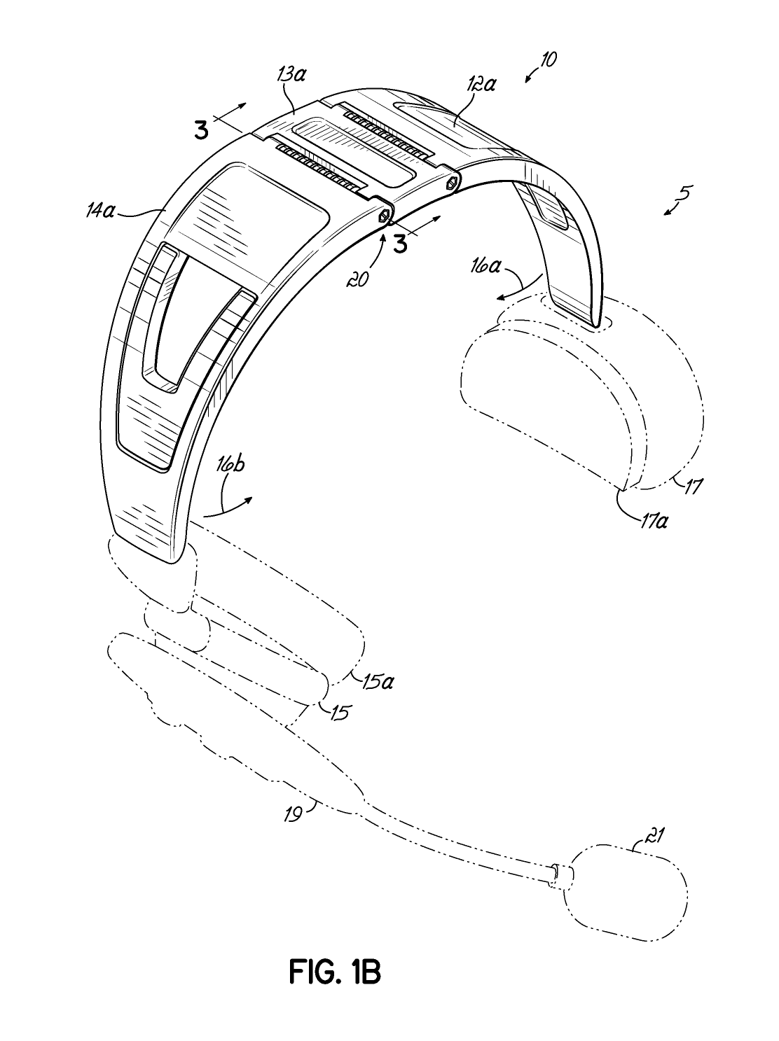

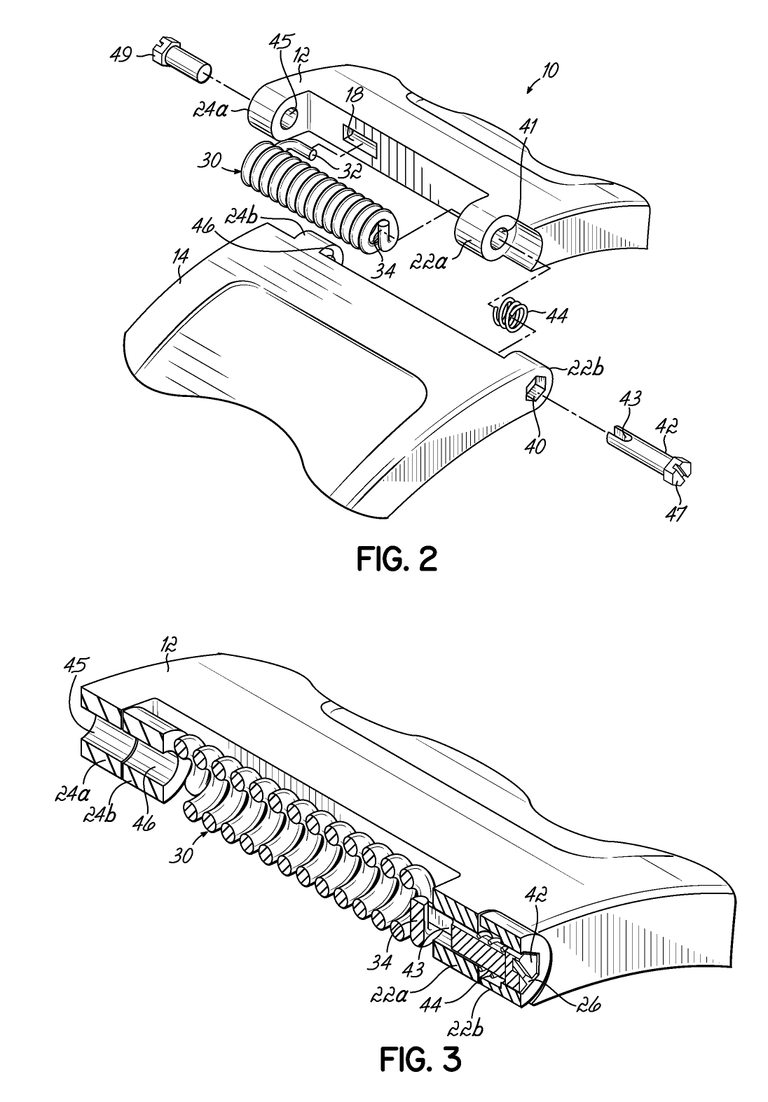

As shown in FIGS. 3 and 4A-4C, a bias spring member 44 is positioned around the adjuster bolt 42, and seats within the front bushing 22b. The bias spring 44 is disposed inside bushing 22b and is contained between the bushing 22a and the head of the adjuster bolt 42, biasing the adjuster bolt 42 toward the front of the bushing 22b and the end of the pivot joint 20. The opening 40 in bushing 22b is shaped to correspond with the shape of the shaped head 47 of bolt 42 so that the shaped head 47 seats in the shaped opening 40. In that way, bolt 42 and bushing 22b are keyed together to couple them together mechanically so that torque forces from spring 30 are translated to arm 14. The shape also dictates the adjustable positions of the headset. That is, the adjustment will generally be in discrete steps based on the shape of the head 47 and opening 40. For a hexagonal shape of head 47, for example, the adjustment increments are essentially ⅙ of the full rotation of the bolt 42. The discrete steps are a result of the head 47 again having to seat in the opening 40. The head 47 of the adjuster bolt 42 in the illustrated embodiment is hex-shaped, which fits the hex shape of opening 40 at the front face of the bushing 24b. When the head 47 of adjuster bolt 42 fits into opening 40, the adjuster bolt 42 is biased by spring 30 to rotate along with the bushing 22b and the arm 14. The torsion spring 30 exerts torque on the adjuster bolt 42 through its leg 34 that extends through a slot 43 at the other end of the adjuster bolt 42. While the illustrated embodiment shows bolt 42 with a slot 43 that receives leg 34, the bolt 42 and spring 30 might be otherwise configured so that the end of the bolt 42 mechanically engages the end of the spring. The torque on bolt 42 and head 47 is then exerted against the bushing 22b and hence the arm 14. The arm 14 is therefore biased relative to the arm 12 through the action of the torsion spring 30 on the adjuster bolt 42. By adjusting the bolt 42, the squeezing force provided by the arms of headset 10 may be adjusted.

FIGS. 4A through 4C illustrate the process of adjusting the torsion in the torsion spring 30 in order to vary the strength of compression of the headband 10 from the relative torque of the headband arms 12, 14. To turn the bolt 42, the bolt is moved or translated along the pivot axis to the rear part of the bushing 22b. The rear part includes an opening dimension that does not restrict rotation of the head of the adjuster bolt 42, and therefore, the head 47 is unseated from shaped opening 40. For example, the opening 40 has a forward portion 50 (see FIG. 4A) that has the shape (e.g., hex shape) corresponding to the shape of head 47 of bolt 42. As illustrated in FIGS. 3 and 4C, when the bolt is biased toward forward portion 50 and shaped opening 40 by the action of spring 44, the head 47 seats in the bushing portion 50 that corresponds with opening 40. As may be appreciated, the shapes of head 47 and the opening 40 in portion 50 are configured to be appropriately keyed together so that, when seated, bolt 42 will not turn without bushing 22b and arm 14 rotating as well. Hence, the spring 30 translates its force to arm 14, as noted to rotate arm 14 relative arm 12.

However, opening 40 also has a larger rear portion 51 behind shaped forward portion 50. The larger portion 51 of the busing is shaped and sized appropriately such that the head 47 freely rotates when it is positioned in alignment with portion 51. FIGS. 4A and 4B illustrate the translation and rotation of bolt 42 to adjust the torsion of spring 30.

Turning to FIG. 4A, by translating or pressing the adjuster bolt 42 into pivot joint 20 in the axis direction shown by arrow 52 (compressing the bias spring 44 in the process), the head of the bolt 42 is unseated or otherwise disengaged from portion 50 of the bushing 22b, and is free to rotate. A screwdriver or other suitable tool can be used to rotate the adjuster bolt 42 as shown by arrow 54 in FIG. 4B. The disengaged or unseated bolt 42 is translated so that head 47 sits in the larger portion 51 of opening 40, and is free to rotate. Although the adjuster bolt 42 as shown in FIGS. 1-4C accepts a flathead screwdriver, as an alternative, the head of the adjuster bolt may accept a hex key, crosshead, or other screwdriver as known in the art. Rotation of bolt 42 rotates the slotted section 43, and causes a corresponding rotation of the leg 34. This action winds the spring. Depending on the direction of the rotation, this increases or decreases the torsion of the torsion spring 30. Once the desired rotation is reached, the adjuster bolt 42, in its new discrete rotational position, is then allowed to return to its biased position (direction arrow 56, via the force of the bias or bias spring 44) where the head of the bolt 42 in again seated within the frame 26. As noted above, the new position will be some discrete step amount from the original position based on the shaped head 47 and opening 40. The increased or decreased torsion in the torsion spring 30 then translates into a greater or lesser torque force exerted upon the arms 12, 14 for any given relative rotational position of the arms 12, 14. The adjustment member, which includes bolt 42, therefore allows for the torsion in the torsion spring 30 to be adjusted as desired by the user.

Accordingly, the headset of the invention provides a readily adjustable configuration that allows the comfort and wearability of the headset to be adjusted as needed. For example, as the spring 30 loses some of its spring force due to use and age, it may be adjusted. For different users, the headset of the invention may be readily adjusted quickly to provide an increased or decreased force on the head of the wearer for both comfort and for properly securing the headset. The adjustment is easy to facilitate by a user, and thus, improves the wearability of the headset.

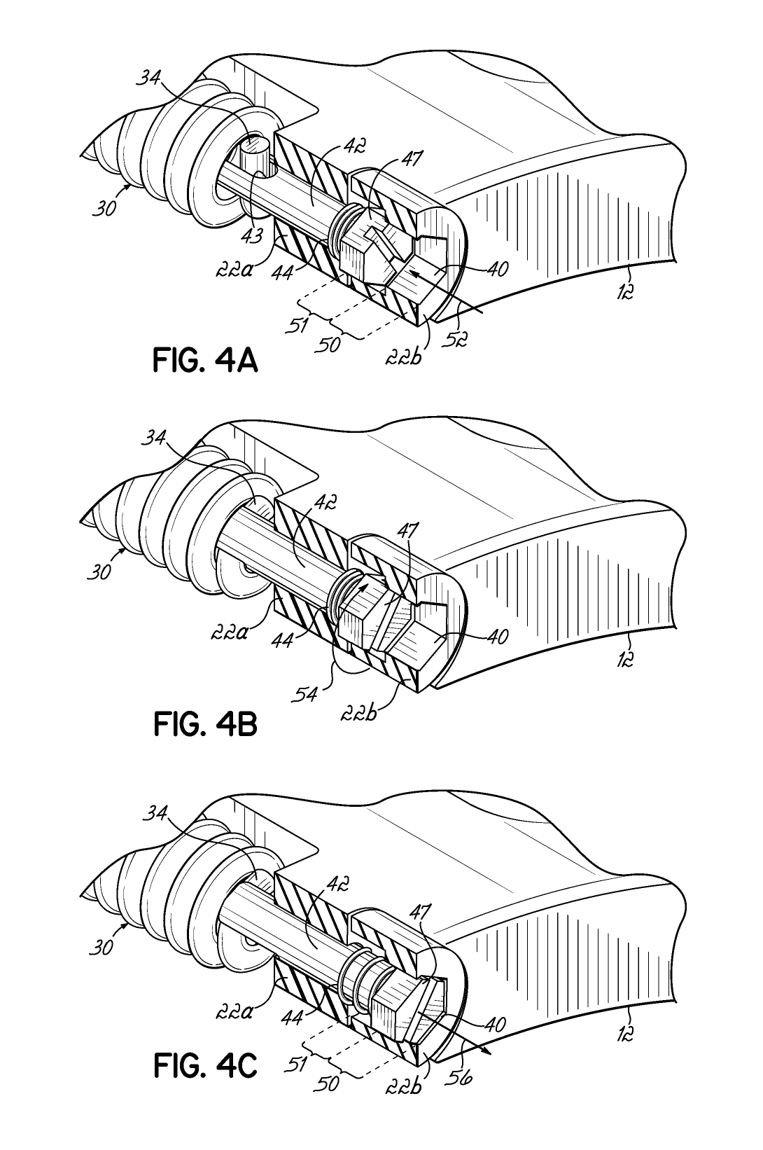

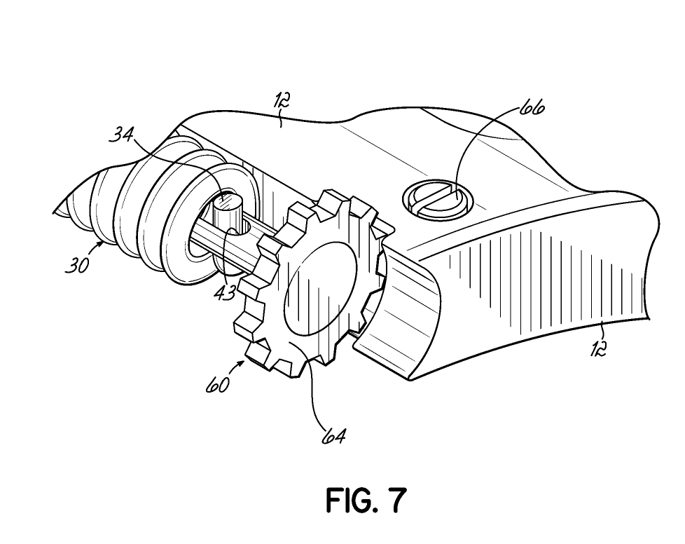

An alternate embodiment of the headset is shown in FIGS. 5-7, where like numbers denote like components. In that embodiment, adjustment of the headset is continuous rather than discrete as in the embodiment of FIGS. 4A-4C. That is, the adjustment may be made at an infinite number of positions between the end limits because the adjustment is continuous rather than discrete as determined by the head 47. In FIG. 5, the leg 32 of the torsion spring 30 is directly coupled to the arm 14 in a suitably mechanical fashion. To adjust the torsion in the spring 30, the adjustment member includes a worm gear arrangement 60. The worm gear arrangement 60 includes worm gear 64 that is coupled mechanically to an end of the torsion spring 30, such as by a slotted shaft (FIG. 7). The end of the slotted shaft might be similar to the end of slotted bolt 42 (See FIG. 2). The gear 64 is also coupled to a worm 66. The worm 66 is secured in an appropriate cavity 67 in an arm, and is secured to rotate in the cavity. In that way, the worm 66 is mechanically coupled with arm 12. Any force on worm 66 is translated to arm 12. The worm gear 64 acts on the spring by rotating the worm 66 as shown by arrow 72, such as with a screwdriver or other suitable tool. A corresponding rotation then occurs in the worm gear 64 as shown by arrow 74. This causes rotation of the portion of the gear engaging spring 30. This then adjusts the torsion of the torsion spring 30 relative to the position of the arms 12, 14, which are biased to close in the direction as shown by arrows 76a and 76b. FIG. 7 shows a cut-away view of the engagement of worm gear 64 with spring 30. The number of positions of adjustment based on the continuous rotation of the worm and worm gear is theoretically infinite and bound only by the mechanical end points of rotation for the worm and gear.

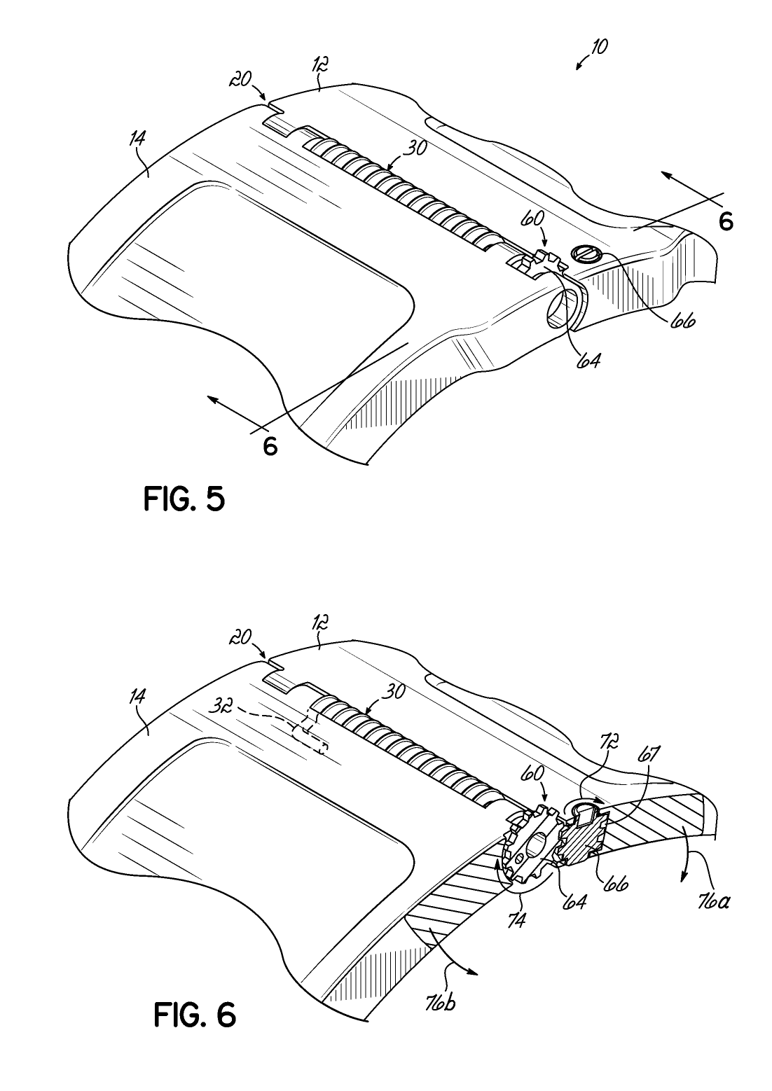

Therefore, in the embodiment shown in FIGS. 5 and 6, rotation of the worm 66 results in a change in the torque exerted by the torsion spring 30 on both arm 14 and on arm 12, through the worm gear 64 and worm 66. Because the axis of rotation of the torque exerted by the torsion spring 30 is perpendicular to the axis of rotation of the worm 66, the worm 66 is not subject to the torque of the spring, and will remain approximately at its set position until another adjustment force is applied to the worm. The torque on worm 66 by worm gear 64 and spring 30 is translated to arm 12. Again, although FIGS. 5 and 6 show the worm 66 as configured for a flathead screwdriver, other suitable rotation interfaces would function as understood by one skilled in the art and discussed above.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

What is claimed is:

1. A headset comprising:
an element to be held to the head of a wearer;
a headband coupled to the element and configured for engaging a head of a wearer to hold the element thereon, the headband including:
a plurality of headband arms coupled to pivot with respect to each other;
a torsion spring positioned between the arms, portions of the torsion spring coupled to the arms for acting on the arms with a torsion force;
an adjustment member coupled between the torsion spring and a headband arm, the adjustment member operable for adjusting the torsion force of the torsion spring to adjust the torsion force on the arms.

2. The headset of claim 1 wherein the adjustment member includes a locked and unlocked position, the adjustment member configured for being movable to adjust the torsion force of the torsion spring when it is in the unlocked position and prevented from being moved in the locked position.

3. The headset of claim 1 wherein the adjustment member includes a bolt having a first end configured to engage a headband arm and a second end coupled with the torsion spring, the bolt movable for being selectively disengaged from the headband arm to be rotated to adjust the torsion force.

4. The headset of claim 3 wherein the adjustment member bolt includes a shaped head configured to seat in a shaped opening to prevent rotation of the bolt, the bolt being movable to unseat the head from the opening to allow rotation to adjust the torsion force.

5. The headset of claim 3 wherein the adjustment member bolt includes a slotted end configured for coupling with an end of the torsion spring, the bolt, when rotated, configured for rotating the end of the torsion spring to adjust the torsion force of the spring.

6. The headset of claim 3 wherein the bolt is biased to engage the headband arm and is selectively disengaged when the bolt is moved to overcome the bias.

7. The headset of claim 1 wherein the adjustment member is configured to provide discrete adjustment of the torsion force.

8. The headset of claim 1 wherein the adjustment member is configured to provide continuous adjustment of the torsion force.

9. The headset of claim 1 wherein the adjustment member includes a worm gear coupled to a worm and rotation of the worm rotates the worm gear to adjust the torsion force of the spring.

10. The headset of claim 1 wherein the adjustment member includes an element with one end coupled with the worm gear and another end coupled with the torsion spring to rotate an end of the torsion spring when the worm gear is rotated, the worm being coupled with at least one headband arm.

11. The headset of claim 1 wherein the element includes at least one speaker.

12. The headset of claim 1 wherein the element includes a pair of speakers, the speakers coupled to the end of respective headband arms.

13. The headset of claim 1 wherein the element includes at least one microphone.

14. The headset of claim 1 wherein the element includes electronics.

15. A headset comprising:
an element to be held to the head of a wearer;
a headband coupled to the element and configured for engaging a head of a wearer to hold the element thereon, the headband including:
a plurality of headband arms;
at least one intermediate member;
the headband arms coupled to pivot with respect to the intermediate member;
a torsion spring positioned between at least one headband arm and the intermediate member, a portion of the torsion spring coupled to the arm for acting on the arm with a torsion force;
an adjustment member coupled between the torsion spring and headband arm, the adjustment member operable for adjusting the torsion force of the torsion spring to adjust the torsion force on the arm.

16. The headset of claim 15 wherein the adjustment member includes a bolt having a first end configured to engage a headband arm and a second end coupled with the torsion spring, the bolt movable for being selectively disengaged from the headband arm to be rotated to adjust the torsion force.

17. The headset of claim 16 wherein the adjustment member bolt includes a shaped head configured to seat in a shaped opening to prevent rotation of the bolt, the bolt being movable to unseat the head from the opening to allow rotation to adjust the torsion force.

18. The headset of claim 16 wherein the adjustment member bolt includes a slotted end configured for coupling with an end of the torsion spring, the bolt, when rotated, configured for rotating the end of the torsion spring to adjust the torsion force of the spring.

19. The headset of claim 16 wherein the bolt is biased to engage the headband arm and is selectively disengaged when the bolt is moved to overcome the bias.

20. The headset of claim 15 wherein the adjustment member includes a worm gear coupled to a worm and rotation of the worm rotates the worm gear to adjust the torsion force of the spring.

21. The headset of claim 20 wherein the adjustment member includes an element with one end coupled with the worm gear and another end coupled with the torsion spring to rotate an end of the torsion spring when the worm gear is rotated, the worm being coupled with at least one of the headband arm or the intermediate member.

22. The headset of claim 15 wherein the element includes at least one of a speaker, a microphone, or electronics.

23. The headset of claim 15 wherein the adjustment member is configured to provide discrete adjustment of the torsion force.

24. The headset of claim 15 wherein the adjustment member is configured to provide continuous adjustment of the torsion force.
